(19) United States
(12) Patent Application Publication
(10) Pub. No.: US 2020/0334605 A1
(43) Pub. Date: Oct. 22, 2020

(54) EMERGENCY RESOURCE SHARING AND EXCHANGE SYSTEM

(71) Applicant: Beijing Yutian Technology Co. Ltd, Beijing (CN)

(72) Inventor: Libao YAN, Beijing (CN)

(21) Appl. No.: 16/686,886

(22) Filed: Nov. 18, 2019

(30) Foreign Application Priority Data
Apr. 17, 2019 (CN) 201910306899.2

(51) Int. Cl. G06Q 10/06; H04L 9/08; H04W 4/90

(52) U.S. Cl. CPC G06Q 10/06315; H04W 4/90; H04L 9/0825

(57) ABSTRACT

The present invention discloses an emergency resource sharing and exchange system, which includes functions of emergency resource query, data aggregation, data distribution, emergency resource storage and access, data conversion, task customization, monitoring and management of emergency sharing platforms, and statistical analysis of shared resources, and establishes an emergency resource sharing security mechanism. The shared emergency resources mainly include emergency materials, emergency reserves, emergency experts, guarantee teams, social resources, GIS resources, and emergency vehicles and so on. The present invention provides collection and centralized storage of emergency resource data of all departments based on big data technology, provides a unified external query interface by adopting SOA architecture to realize the unified management and sharing exchange of various emergency resources, which greatly improves the unified dispatch of emergency resources and the cooperative operation efficiency of emergency command by the emergency management department.

### TECHNICAL FIELD

The present invention relates to the field of emergency resource management, in particular to an emergency resource sharing and exchange system.

### BACKGROUND ART

Since the 1990s, with the development of computer technology and network technology, social informatization degree has been continuously improved. After years of construction, China's network environment has initially formed, which provides great convenience for the realization of information resources sharing. With the rapid development of social economy, information resources have become the valuable resources and wealth of the whole society, and the demand for information sharing is increasing. Especially in the emergency industry, Chinese government departments have established multiple business systems related to emergency, while the information among the systems is not shared, forming an information island. In addition, an important task in the current emergency management in the country is how to classify emergency resources to promote cross-sectoral and cross-industry sharing of emergency resources, meet the needs of the government, enterprises and social organizations, and make the entire emergency industry fully share emergency resources. Perfection of the sharing mechanism of social emergency resources information is an important basis for improving the ability of cities to cope with various disasters and public emergencies, an important prerequisite for improving emergency command and dispatch, and an important guarantee for realizing joint operations and rapid response of various emergency forces. However, at present, the sharing of emergency resources in our country has not been effectively exploited and utilized, seriously restricting the efficiency of cooperative operations of emergency command, which has become an urgent problem to solve in emergency management construction.

### CONTENTS OF THE INVENTION

The present invention provides an emergency resource sharing and exchange system, solving the problems of emergency resource information islands in the emergency industry.

The present invention is realized by the following schemes: an emergency resource sharing and exchange system includes:

Resource Query: All the related resources shared by emergency resources, such as emergency materials, emergency reserves, emergency experts and guarantee teams can be queried.

Data Aggregation: Support the function that data are aggregated by data sources from various branches into data centers. The process of collecting public data can be seen as a process of data aggregation, which collects emergency resource data from various business departments through the system, and then collects them into the cache database of the data center. Consistent data are obtained through comparison, verification and conversion of data management system.

Data Distribution: Data distribution is the process of providing data to all data users actively from the data center. Data are distributed from the data center to various data use departments to realize data sharing and information linkage by publishing data services according to the rules of data use rights.

Access: Real-time and on-demand data access services are provided, and access support to various technical platforms is provided through a unified standard data interface, using XML as the standard data format by standard Web services.

Data Conversion: Data exchange services can convert data from a database into standard XML data sets. Various heterogeneous data are converted to public data with uniform standards and specifications, consistency and integrity through the data conversion module.

Task Customization: Data interface systems shall allow users to configure and manage related services by themselves, such as data extraction service, data sending service, data receiving service, data storage service, etc.

Monitoring Management: Monitoring management of data services, user rights management, viewing of operation log and performance statistics. The details of data exchange can be recorded and tracked through the data service log. Data exchange nodes are managed and security strategy guide and server security management configuration are provided.

Statistical Analysis: For shared emergency resources, multiple dimensional analysis of emergency resources and various data can be made in accordance with the designated areas marked by administrative regions or maps.

Data Sharing Security: A sound security management guarantee system is established. In view of various security threats and risks that may be encountered in the construction of emergency resource sharing and exchange system, effective security measures are taken and the information security system of the system is constructed to ensure the confidentiality, integrity, availability, non-repudiation, controllability and auditability of the information system, and ensure that the information system can operate safely, stably and reliably to provide security for the system.

Data Exchange Mode: The platform interface with related business systems is reserved in the construction of emergency resource sharing system to ensure compatibility and consistency of business, realize emergency resource sharing and break away Information Island. From the current application situation, these business systems may be constructed with different architectures and different development languages, so we consider a variety of data interface forms, including Rest, JDBC, Thrift, Web Service and other interface types.

Furthermore, the above resource query also includes emergency knowledge which is composed of a rich and comprehensive emergency knowledge database, and plays a great role in assistant decision-making of emergency command. Emergency knowledge database shall include all kinds of emergency knowledge related to emergency business in all aspects, and can provide abundant emergency knowledge learning resources for relevant emergency users, so that emergency users can better understand emergency business and use emergency management system to deal with related emergencies.

Furthermore, the resource query mentioned also includes the query of emergency resources through GIS, (1) Graphical query: the emergency information can be queried in the scope of the box through dropping down the box on the map, and the detailed information of the materials and teams needed for the emergency can be checked. (2) Attribute query: query in accordance with the query conditions (fuzzy matching according to the name of emergency resources), and locate emergency resources information (such as the location of rescue teams, materials and social resources.) on the map for display.

Furthermore, the statistical analysis mentioned also includes the exported statistical results in the form of Word or PDF.

Furthermore, the data sharing security mentioned also includes identity authentication, data transmission security, data encryption and decryption, access control and resource control.

Furthermore, the identity authentication also includes that the solutions of the data exchange and authentication platform, based on the authentication of the central authentication server, should aim at resource integration, and realize single sign-on and integration of information resources in various business systems more safely through unified authentication and access control of the user identity for data exchange.

Furthermore, the data encryption and decryption mentioned also includes asymmetric encryption algorithms adopted to encrypt and store some key sensitive data stored in the database, such as user passwords, emergency resource data and base stations, so as to improve the security of the system.

Furthermore, the data transmission security mentioned also includes that the system combines with SSL secure link and uses https protocol to ensure link security, and publishes shared services into service interface based on SSL. As a special security protocol, it provides secure transmission channels for both parties of communications.

Compared with the existing technology, the present invention has the following advantages and beneficial effects:

The present invention provides collection and centralized storage of emergency resource data of all government departments based on big data technology, and provides a unified external query interface to realize unified management, sharing and exchange of various emergency resources, which greatly improves the unified dispatch of emergency resources and the cooperative operation efficiency of emergency command by the emergency management department.

### ILLUSTRATIONS

In order to make contents of the present invention understood more easily and clearly, the present invention is further described in detail in accordance with specific embodiments of the present invention and figures, where

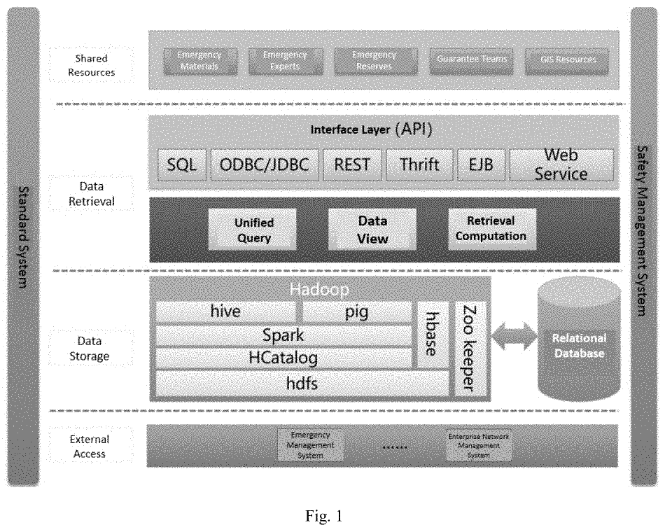

FIG. 1 shows the architecture of an emergency resource sharing and exchange system in an embodiment of the present invention.

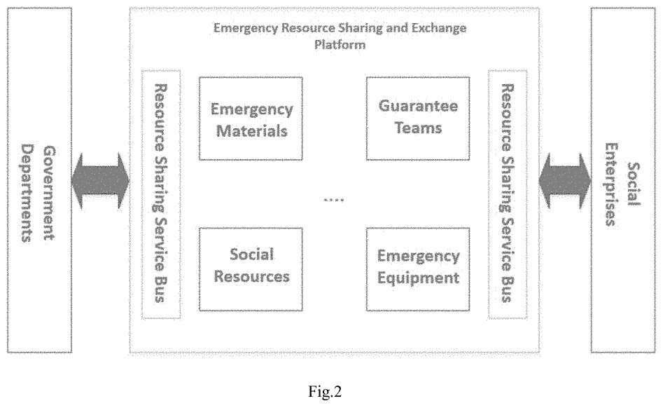

FIG. 2 shows the flowchart of an emergency resource sharing and exchange system in an embodiment of the present invention.

### EMBODIMENTS

The following contents are detailed descriptions for embodiments of the present invention combined with figures. The following embodiments are used to describe the present invention but are not used to limit the scope of the present invention.

### Embodiment 1

As shown in FIG. 1, the present invention provides the architecture diagram of an emergency resource sharing and exchange system, and the architecture of the system is divided into data access layer, data storage layer, data retrieval (API interface) layer and shared resource layer from bottom to top. The above layers separately provide the corresponding data access and storage services, general supporting component services, basic support platform services to support development and operation, and specific business applications realized by underlying components and services, and show specific business applications to end users.

Shared Resource Layer: Emergency materials, emergency reserves, emergency experts, guarantee teams, GIS resources and other shared emergency resources provided outwards are mainly included.

Data Retrieval Layer: The emergency resource sharing and exchange system provides a unified interface for information sharing, business interworking, information query and other services. The system provides different interfaces such as JDBC, Thrift, REST, EJB, WebService and SQL. The data loading, data platform, query engine and computing engine of resource sharing platforms provide a variety of functions and interfaces. Specific implementation shall be made according to business system construction requirements for optimization to realize efficient computing, storage management and pre-processing of business data.

Data Storage Layer: Data resource layer provides mechanism of data storage, management and resource access, and provides data and resource services for the above layers. Basic information database, GIS information database, emergency resource database, resource sharing database, network resource database and emergency knowledge database are mainly established. The structured data is mainly stored in oracle relational database, and unstructured and semi-structured data are stored in Hadoop big data platform, which supports the dynamic expansion of server storage capacity and provides big data analysis for command decision-making and emergency decision-making support. The big data platform adopts Hadoop+Hbase+Spark architecture, supports structured, unstructured and semi-structured data, backs dynamic expansion of file storage, and provides distributed storage of massive data and high-performance distributed computing framework. Data analysis such as data digging analysis and decision-making support is completed.

Data Access Layer: Access to emergency management system of all departments, enterprise network management system and other external systems, and emergency resources, emergency basic information and other data are extracted from related systems.

### Embodiment 2

As shown in FIG. 2, the present invention provides a flowchart of an emergency resource sharing and exchange system. The basic flow includes:

Step 1: The government's emergency management departments and social enterprises submit emergency resources of their departments through the resource sharing service bus of the system (realized by adopting SOA architecture and REST is the main interface mode).

Step 2: Emergency resource sharing platform is used for storage. Emergency resources stored mainly include emergency materials, emergency equipment, emergency experts, guarantee teams, social resources and emergency personnel.

Step 3: When the government's emergency management departments and social enterprise emergency departments have emergencies, and they need to query the schedulable emergency resources, they can query the emergency materials within the scope of authority through the resource sharing service bus of the system and quickly dispatch emergency resources for emergency disposal.

Emergency resource sharing system describes all kinds of emergency resources from different departments through metadata, maintains the metadata catalog information of the whole emergency resources, establishes metadata catalog tree, provides metadata catalog service, and realizes the sharing of emergency resources among all departments and enterprises. The demand side of emergency resources is mainly government departments and social enterprises. The government departments include emergency communication management departments of provincial, prefectural and municipal governments, and the social enterprises mainly include baseline telecom enterprises in the emergency communication industry.

The specific embodiments of the present invention described above do not constitute a limitation of the protection scope of the present invention. Any other corresponding changes and transformations made according to the technical concept of the present invention shall be included in the protection scope of the of the present invention claim.

What is claimed:

1. An emergency resource sharing and exchange system is characterized in that:
Resource Query: All the related resources shared by emergency resources, such as emergency materials, emergency reserves, emergency experts and guarantee teams can be queried;
Data Aggregation: Support the function that data are aggregated by data sources from various branches into data centers. The process of collecting public data can be seen as a process of data aggregation, which collects emergency resource data from various business departments through the system, and then collects them into the cache database of the data center. Consistent data are obtained through comparison, verification and conversion of data management system;
Data Distribution: Data distribution is the process of providing data to all data users actively from the data center. Data are distributed from the data center to various data use departments to realize data sharing and information linkage by publishing data services according to the rules of data use rights;
Access: Real-time and on-demand data access services are provided, and access support to various technical platforms is provided through a unified standard data interface, using XML as the standard data format by standard Web services;
Data Conversion: Data exchange services can convert data from a database into standard XML data sets. Various heterogeneous data are converted to public data with uniform standards and specifications, consistency and integrity through the data conversion module;
Task Customization: Data interface systems shall allow users to configure and manage related services by themselves, such as data extraction service, data sending service, data receiving service, data storage service, etc;
Monitoring Management: Monitoring management of data services, user rights management, viewing of operation log and performance statistics. The details of data exchange can be recorded and tracked through the data service log. Data exchange nodes are managed and security strategy guide and server security management configuration are provided;
Statistical Analysis: For shared emergency resources, multiple dimensional analysis of emergency resources and various data can be made in accordance with the designated areas marked by administrative regions or maps;
Data Sharing Security: A sound security management guarantee system is established. In view of various security threats and risks that may be encountered in the construction of emergency resource sharing and exchange system, effective security measures are taken and the information security system of the system is constructed to ensure the confidentiality, integrity, availability, non-repudiation, controllability and auditability of the information system, and ensure that the information system can operate safely, stably and reliably to provide security for the system;
Data Exchange Mode: The platform interface with related business systems is reserved in the construction of emergency resource sharing system to ensure compatibility and consistency of business, realize emergency resource sharing and break away Information Island. From the current application situation, these business systems may be constructed with different architectures and different development languages, so we consider a variety of data interface forms, including Rest, JDBC, Thrift, Web Service and other interface types.

2. The emergency resource sharing and exchange system described in the claim 1 is characterized in that the resource query mentioned also includes emergency knowledge which is composed of a rich and comprehensive emergency knowledge database, and plays a great role in assistant decision-making of emergency command. Emergency knowledge database shall include all kinds of emergency knowledge related to emergency business in all aspects, and can provide abundant emergency knowledge learning resources for relevant emergency users, so that emergency users can better understand emergency business and use emergency management system to deal with related emergencies.

3. The emergency resource sharing and exchange system described in the claim 1 is characterized in that the daily zero report management mentioned also includes daily zero report receiving, daily zero report collation and daily zero report submission.

4. The emergency resource sharing and exchange system described in the claim 1 is characterized in that the resource query mentioned also includes the display of emergency resources and query of emergency resources through GIS, (1) Graphic Query: the emergency information can be queried in the scope of the box through dropping down the box on the map, and the detailed information of the materials and teams needed for the emergency can be checked; (2) Attribute Query: query in accordance with the query conditions (fuzzy matching according to the name of emergency resources), and locate emergency resources information (such as the location of rescue teams, materials and social resources.) on the map for display.

5. The emergency resource sharing and exchange system described in the claim 1 is characterized in that the statistical analysis mentioned also includes the exported statistical results in the form of Word or PDF.

6. The emergency resource sharing and exchange system described in the claim 1 is characterized in that the data sharing security mentioned also includes identity authentication, data transmission security, data encryption and decryption, access control and resource control.

7. The emergency resource sharing and exchange system described in the claim 6 is characterized in that the identity authentication also includes that the solutions of the data exchange and authentication platform, based on the authentication of the central authentication server, should aim at resource integration, and realize single sign-on and integration of information resources in various business systems more safely through unified authentication and access control of the user identity for data exchange.

8. The emergency resource sharing and exchange system described in the claim 6 is characterized in that the data encryption and decryption mentioned also includes asymmetric encryption algorithms adopted to encrypt and store some key sensitive data stored in the database, such as user passwords, emergency resource data and base stations, so as to improve the security of the system.

9. The emergency resource sharing and exchange system described in the claim 6 is characterized in that the data transmission security mentioned also includes that the system combines with SSL secure link and uses https protocol to ensure link security, and publishes shared services into service interface based on SSL, As a special security protocol, it provides secure transmission channels for both parties of communications.
